(19) United States
(12) Patent Application Publication
(10) Pub. No.: US 2010/0236567 A1
(43) Pub. Date: Sep. 23, 2010

(54) Cosmetic Substance Dispenser

(76) Inventors: Craig Carroll, Newport Beach, CA (US); Steve Armstrong, San Juan Capistrano, CA (US)

Correspondence Address: John Karl Buche;BUCHE & ASSOCIATES, P.C., 875 PROSPECT, SUITE 305, LA JOLLA, CA, 92037, US

(21) Appl. No.: 12/729,584

(22) Filed: Mar. 23, 2010

Related U.S. Application Data
(60) Provisional application No. 61/162,674, filed on Mar. 23, 2009.

(51) Int. Cl. A45D 40/26; B23P 17/04

(52) U.S. Cl. 132/200; 132/218; 401/121; 401/129; 29/428

(57) ABSTRACT

Disclosed are a dispenser and related methods for dispensing substances having fluid or liquid, semi-liquid, quasi-liquid, or paste-like properties (e.g., mascara, lip moisturizer, or the like).

### CROSS-REFERENCE TO RELATED APPLICATIONS

This application claims the benefit of U.S. Prov. Pat. App. Ser. No. 61/162,674 (filed Mar. 23, 2009) entitled “Toggling cosmetic substance dispenser.”

### STATEMENT REGARDING FEDERALLY SPONSORED RESEARCH OR DEVELOPMENT

Not applicable.

### BACKGROUND OF THE INVENTION

1. Field of Invention

The present invention is in the field of apparatuses for dispensing cosmetic substances. Specifically, the present application is in the field of apparatuses for dispensing and applying products having fluid or liquid, semi-liquid, quasi-liquid, or paste-like properties (e.g., mascara, lip moisturizer, or the like).

2. Background of the Invention

Existing dispensers in the present field of invention typically comprise (1) a container for a viscous substance, (2) a wiper, and (3) a cap featuring a coaxial spindle plus applicator extending therefrom. Using the cap as a handle, the spindle plus applicator is normally for accessing the substance within the container. Typically, the spindle plus applicator is inserted to the substance within the container and withdrawn whereby the applicator collects substance as it passes through the container. The wiper removes excess substance from the spindle plus applicator as the assembly exits the container. The withdrawn substance might ultimately be applied to a target via contact between the target and applicator. During periods of non-use, the cap typically closes the container with the spindle plus applicator disposed therein.

The operation of existing dispensers is less than ideal for the typical user. First, two free hands are required to (1) disengage the cap from the container and (2) insert and withdraw the spindle plus applicator from the container. Second, if the cap is not positioned correctly during periods of non-use, the substance within the dispenser will dry-out or evaporate after a short time.

Operation of the wiper is also less than ideal for the typical user. Normally, the wiper circumscribes the opening of the container whereby excess substance is removed from the applicator during its withdrawal from the container. Problems arise because the wiper does not usually interact with the spindle which often results in the spindle becoming coated with substance. Furthermore, interaction between the spindle plus applicator and the wiper upon a skew insertion into the container often produces substance buildup on the exterior of the wiper. These conditions are messy and can cause undesirable substance transfer (i.e., substance transferred to locations other than the original target).

U.S. Pat. No. 6,371,129 to Le Bras-Brown, addressed the aforementioned dispenser disadvantages via a slider mechanism on the spindle plus applicator. In Le Bras-Brown the user manipulates the slider mechanism to introduce and withdraw the applicator from the substance within the container. The cap may be open and closed manually or via coupling to the slider device.

U.S. Pat. No. 4,687,364 to Kingsford, addressed the aforementioned dispenser disadvantages via a pop-up mechanism on the spindle plus applicator. In Kingsford the container featured a compression spring at one end of the spindle plus applicator whereby the spring constantly forced the applicator out of the container. Cap placement on the container forced the spindle plus applicator within the container thereby compressing the spring and permitting substance collection on the applicator. Conversely, cap removal released the compressed spring to pop-up the substance coated applicator from within the container.

Slider and pop-up mechanisms are also less than ideal. First, pop-up still requires the use of two hands for removing the cap. Second, sliders typically require two different routines for operating the dispenser: (1) disengage the cap; and (2) manipulate the slide mechanism. Furthermore, sliders produce a relatively large amount of friction between the slider mechanism and the container. Finally, both slider and pop-up dispensers are: complex; require expensive adhesives for securing component parts; do not solve the problem of undesired delivery; and, are unsuitable to high volume manufacturing processes.

Notwithstanding the known dispensers, there is still the need for further improvements in cosmetic dispensers for fluid or liquid, semi-liquid, quasi-liquid, or paste-like properties (particularly mascara and lip moisturizer).

### SUMMARY OF THE INVENTION

Accordingly, it is an object of the present application to provide a dispensing apparatus without a standard detachable lid or cap, but which apparatus still protects the applicator from outside corruption, dry-out, and/or evaporation.

It is yet a further object of the present application to provide a dispensing apparatus which may be opened and closed sufficiently with one hand.

It is an even further object of the present application to provide a dispensing apparatus wherein the spindle plus applicator does not skewly enter and exit the container, and wherein accumulation of substance on the spindle is minimized.

It is yet still a further object of the present application to provide a dispensing apparatus with component parts that minimally interact whereby production is easier.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1A is a side view of a closed dispenser 1.

FIG. 1B is a side view of an open dispenser 1.

FIG. 2 is a perspective view of an open dispenser 1.

FIG. 3A is a longitudinal cross-section of a closed dispenser 1.

FIG. 3B is a longitudinal cross-section of open dispenser 1.

FIG. 3C is a longitudinal cross-section of lock/unlock open dispenser 1.

FIG. 3D is a disassembled view of a closed dispenser 1.

FIG. 3E is a disassembled view of a open dispenser 1.

FIG. 3F is a disassembled view of a lock/unlock open dispenser 1.

FIG. 4 is an enlarged and truncated cross-section of the front of the closed dispenser 1.

FIG. 5 is an exploded view of the dispenser 1.

FIG. 6A is a side view of a closed dispenser 100.

FIG. 6B is a side view of an open dispenser 100.

FIG. 7 is a perspective view of an open dispenser 100.

FIG. 8A is a longitudinal cross-section of a closed dispenser 100.

FIG. 8B is a longitudinal cross-section of open dispenser 100.

FIG. 9 is an enlarged and truncated cross-section of the front of the closed dispenser 100.

FIG. 10 is an exploded view of the dispenser 100.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Generally, the dispenser of the present application is an all-in-one cosmetic substance dispenser. In other words, the cosmetic substance is contained and dispensed by a single dispenser apparatus. Suitably, the dispenser features a spindle plus applicator that translates in and out of the dispenser. While within the dispenser, the applicator accumulates a suitable amount of the contained cosmetic substance. While outside the dispenser, the applicator, loaded with substance, is suitably exposed for the directed delivery of the accumulated substance. The preferable operation of the dispenser achieves substance delivery to a target via contact between the loaded applicator and the target.

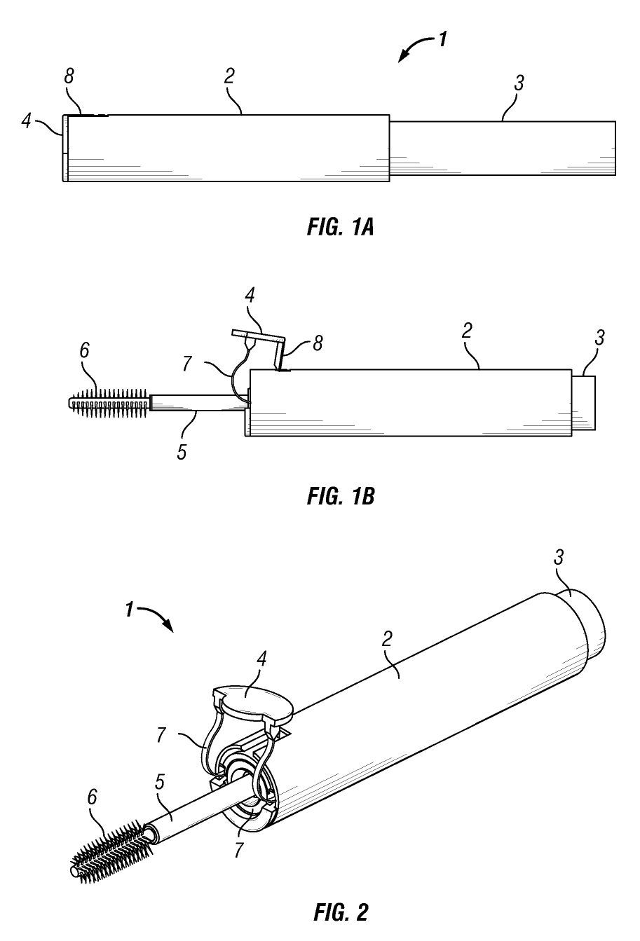

FIG. 1A is a side view of a closed dispenser 1. More specifically, the figure shows a dispenser 1 with a cylindrical body 2, fully extended plunger 3, and closed cap 4. FIG. 1B is a side view of an open dispenser 1. More specifically, the figure shows a dispenser 1 with a cylindrical body 2, a depressed plunger 3, an open cap 4, and a protracted spindle 5 plus applicator 6. FIG. 2 is a three-dimensional perspective of the open dispenser of FIG. 1B. As discussed further below, the closed dispenser 1 of FIG. 1A is opened as in FIG. 1B or 2 via depressing the plunger 3 whereby simultaneously the cap 4 disengages the body 2 and the spindle 5 plus applicator 6 protrude from the exposed opening.

Referring again to FIG. 1A, the closed dispenser 1 is generally in the form of a hollow elongated cylinder. The plunger 3 defines a hemicylindrical end of the closed dispenser 1 and is preferably slightly less in diameter than the body 2 whereby the plunger 3 depressibly and coaxially merges within the body 2. Referring now to FIGS. 1B and 2, the plunger 3 can be substantially depressed into the body 2. As discussed later below, the depressive movement of the plunger 3 opens the cap 4 and protracts the spindle 5 plus applicator 6.

Still referring to FIGS. 1B and 2, the applicator 6 may preferably be in the nature of a twisted-in-wire-brush or other suitable design for application of substances with fluid or liquid, semi-liquid, quasi-liquid, or paste-like properties. Alternatively, the applicator 6 may be in the nature of a miniature comb, preformed swab, sponge applicator, flocked applicator and the like.

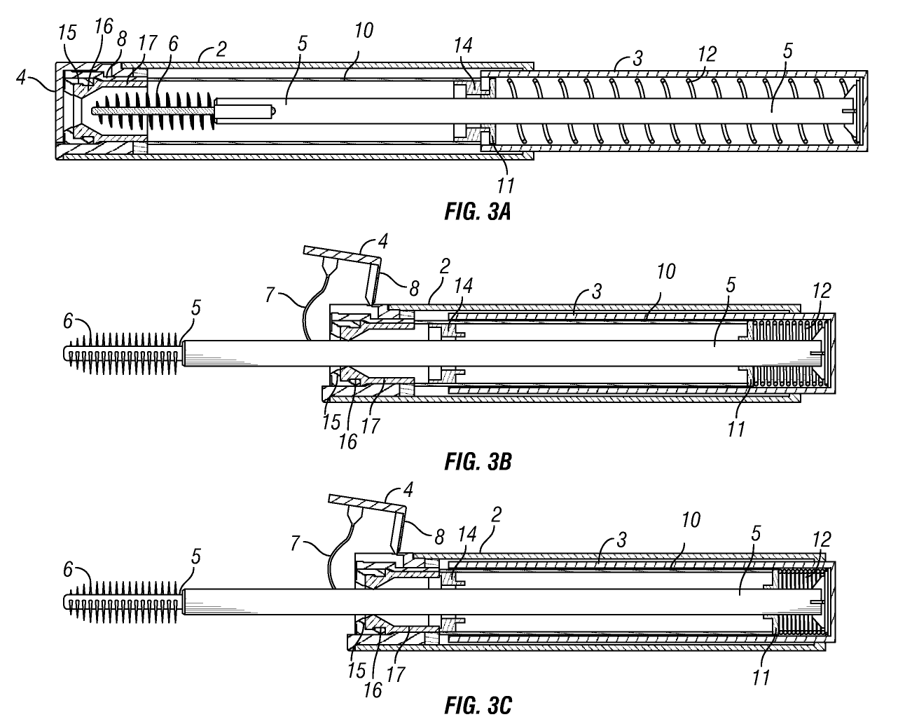

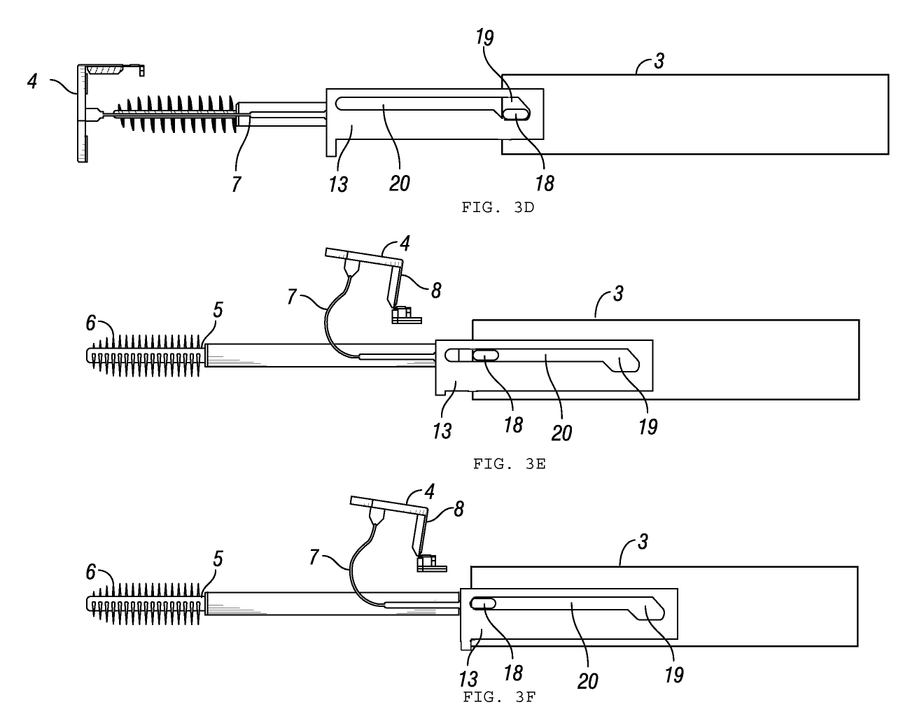

FIGS. 3A, 3B, and 3C are respectively longitudinal cross-sections of the closed, open, and lock/unlock dispenser 1. FIGS. 3D, 3E, and 3F are respectively longitudinal views of components respectively within the closed, open, and lock/unlock dispenser 1 of FIGS. 3A, 3B, and 3C. FIGS. 3A through 3C depict the situation of the internal components during operation of the dispenser 1. As seen generally in the three figures, the dispenser 1 internally typically comprises three integrally associated subassemblies: (1) the spindle assembly made up of the spring 12, the spindle 5, the ratchet 14, and the applicator 6; (2) the reservoir assembly comprising the reservoir 10, the rear seal 11, the gear 17 and wiper 16, and the front seal 15; and (3) the cap assembly made up of the cap 4, the cap shafts 7, the cap guide 8, and the press 13.

Inside the closed dispenser 1 of FIG. 3A, the spindle assembly movably occupies the length of the dispenser 1. More specifically, the spindle 5 extends from the butt of the plunger 3 through the expanded spring 12 to the applicator 6 within the closed cap 4. Suitably, the ratchet 14 is fixedly attached to a point along the spindle 5. As discussed further below, a portion of the spindle assembly (from the ratchet 14 to the applicator 6) is within the reservoir assembly and preferably submerged in substance.

Still referring to the closed dispenser 1 of FIG. 3A, the reservoir assembly is fixedly positioned within the body 2 opposite to the plunger 3. The reservoir 10 preferably connects internally to the body 2 at the cap 4 end and extends internally toward the plunger 3. The front seal 15, the wiper 16, and the gear 17 fixedly occupy the cap 4 end of the reservoir 10 while the rear seal 11 fixedly occupies the end toward the plunger 3. As mentioned above and discussed further below, the applicator 6, the ratchet 14, and a portion of the spindle 5 are preferably within the reservoir 10 when the dispenser 1 is closed whereby the ratchet 14 is adjacent to the rear seal 11. Also discussed further below, the rear seal 11 slidably, circumferaly, and sealably interfaces with the spindle 5.

Now referring to the closed dispenser 1 of FIGS. 3A and 3D, the cap assembly is preferably externally affixed to the body 2, movably extends internally within the body along the outside of the reservoir 10, and mechanically connects to the plunger 3. Specifically, the cap 4 is connected to the body 2 by the cap guide 8 and held against the front seal 15 of the reservoir by taut cap shafts 7. The interface of the cap 4 with the front seal 15 plugs the front of the reservoir whereby the closed dispenser 1 is capable of containing a substance within the reservoir 10. As discussed below, the cap shafts are made taut by the mechanical connection of the cap press 13 to the plunger 3.

Inside the open dispenser 1 of FIG. 3B, the spindle assembly is preferably internally shifted when compared with the closed dispenser of FIG. 3A. More specifically, the depression of plunger 3 compresses the spring 12 (between the plunger 3 butt and the reservoir 10) and drives the spindle 5 plus applicator 6 through the dispenser 1, preferably until the spindle 5 plus applicator 6 protrudes from the body 2. As depicted in the figure, the depressed plunger 3 coaxially enters the body 2 and simultaneously coaxially receives the reservoir 10. As depicted in the figure and discussed in further detail below, the ratchet 14 suitably shifts in conjunction with the spindle 5 to an interaction with the gear 17. Also discussed further below, the applicator 6 and spindle 5 interact with the wiper 16 while exiting the body 2 during plunger 3 depression.

Still referring to the open dispenser 1 of FIG. 3B, the reservoir assembly is fixedly positioned within the body 2 opposite to the plunger 3 like in the closed dispenser of FIG. 3A. Although the components of the other subassemblies move during plunger 3 depression, the reservoir assembly maintains a relative position within the body 2. Relative to the reservoir assembly, plunger 3 depression drives the applicator 6 through the reservoir 10 along and through the rear seal 11 whereby the applicator 6 and spindle 5 exit the dispenser 1 at the front seal 15. As the spindle 5 plus applicator 6 move through the reservoir 10, the wiper 16 interacts with the applicator 6 to remove excessive substance thereon. The wiper 16 also typically interacts with the spindle 5 in a similar manner as the rear seal 11 whereby (1) substance is wiped away from the spindle 5 and remains within the reservoir 10, and (2) substance does not leak from the front seal 15. Also during plunger 3 depression, the ratchet 14 usually moves within the reservoir 10 to an interaction with the gear 17 for locking/unlocking the open configuration of the dispenser 1, as discussed further below in connection with FIG. 3C.

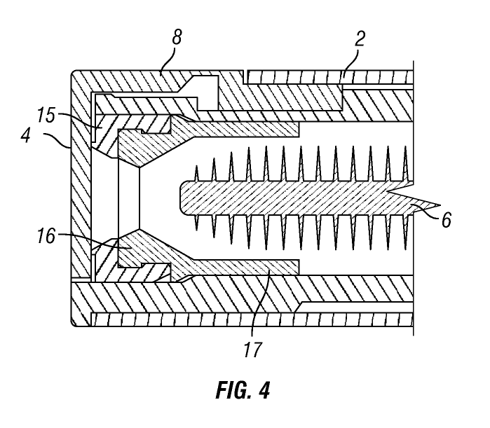

As mentioned above, the reservoir 10 features a front 15 and rear seal 11. Often, fluid materials used in cosmetic applications can quickly dry out when exposed to air. Accordingly, the applicator 6 and cosmetic substance should be cautiously exposed to air. To this end, the reservoir 10 has a rear seal 11 sized to receive the spindle 5 to create a substantially air tight seal without excessive force hindering movement of the spindle therethrough. Rear seal 11 is preferably constructed of an elastomeric material that maintains pliability. Likewise, the reservoir 10 features the front seal 15 for engaging the cap 4 to create a substantially airtight seal while the dispenser 1 is closed. This seal is depicted by FIG. 4. It should be noted, however, that although the dispenser 1 features the wiper 16 which, like the rear seal 11, is sized to receive the spindle 5 the wiper 16/spindle 5 interface need not create an airtight seal. Rather, the wiper 16/spindle 5 interface need only (1) prevent the accumulation of substance on the spindle while outside the reservoir 10, and (2) prevent the leakage of substance from the reservoir 10 during dispenser 1 use. Front seal 15 is preferably constructed of an elastomeric material that maintains pliability.

Referring now to the open dispenser 1 of FIGS. 3B and 3E, the cap assembly is preferably shifted within the dispenser 1 to open the cap 4. Specifically, plunger 3 depression drives the cap press 13 through the body 2 and mechanically protrudes the cap shafts 7 from the body 2 whereby the cap is disengaged from the front seal 15. Preferably, continued protrusion of the cap shafts 7 from the body 2 further separates the cap 4 from the front seal 15 while simultaneously the cap guide 8 pulls the cap 4 off plain whereby the spindle 5 plus applicator 6 may exit the dispenser 1 unobstructedly.

As mentioned above, plunger 3 depression simultaneously opens the cap 4 and protrudes the spindle 5 plus applicator 6. The stated simultaneous action is the result of a two-stage mechanical connection between the plunger 3, the cap assembly, and the spindle assembly. FIG. 3A through 3C depict this process. As seen in FIG. 3A, the mechanical connection between the plunger 3 and the spindle assembly is the interface of the plunger 3 butt with the base of the spindle 5. Still referring to FIG. 3A, the initial mechanical connection between the plunger 3 and the cap assembly is via the nub 18 interacting with the slot 19 of the cap press 13. During plunger 3 depression, the butt of the plunger 3 pushes the spindle plus applicator 5 through the dispenser 1 while the nub 18 pushes the cap press 13. After the cap 4 has opened sufficiently, the nub 18 moves from the slot 19 into the track 20 whereby the cap press 13 no longer moves within the dispenser 1 during continued plunger 3 depression. The two stage mechanical connection permits the cap 4 to open fully while also permitting the applicator 6 to be sufficiently extended from the dispenser 1.

As stated above, plunger depression produces an open dispenser 1 as depicted in FIGS. 3B and 3E. Conversely, plunger 3 extension (via expansion of the spring 12 or otherwise) produces a closed dispenser 1 as depicted in FIG. 3A due to the same mechanical connections and via the reverse of the above stated mechanisms.

FIG. 3C represents the lock/unlock dispenser 1. As mentioned above, plunger 3 depression drives the ratchet 14 to an interaction with the gear 17 within the dispenser 1. As discussed further below, the ratchet 14 and gear 17 alternatingly interact between locking and unlocking engagements.

The locking and unlocking of the dispenser 1 is best illustrated by FIGS. 3A through 3C. As mentioned above, plunger 3 depression from the closed dispenser 1 configuration of FIG. 3A to the open dispenser configuration of FIG. 3C drives the ratchet 14 through the reservoir 10 to a locking engagement with the gear 17. The locking engagement permits partial extension of the plunger 3 as depicted in FIG. 3B, but prevents the spring 12 force from returning the dispenser 1 to a closed configuration. As a result, the dispenser 1 stays open as in FIG. 3B. Plunger 3 depression from the open dispenser 1 configuration of FIG. 3B to the open dispenser 1 configuration of FIG. 3C moves the ratchet 14 through the reservoir 10 to an unlocking engagement with the gear 17. The unlocking engagement permits full extension of the plunger 3 and, as a result, the dispenser 1 reverts automatically under the spring 12 force to the closed configuration depicted in FIG. 3A.

Common gear and track mechanisms found in retractable pens can be used to accomplish the locking and unlocking engagements between the ratchet 14 and the gear 17 (i.e., to protract and retract the applicator 6). The present invention may be integrated into retractable pen bodies having varied retraction methods. The figures illustrate a dispenser 1 with an embodiment of the present invention and having one common retraction method. Other mechanisms are known by those skilled in the art and include, but are not limited to: plunger ratchet mechanisms, twist cam mechanisms, and latching push button mechanisms. Any of these return mechanisms, or others not specifically named, may also be used in a dispenser like unto the dispenser 1 depicted in the drawings.

FIGS. 1 through 3C depict a preferable dispenser 1 operation. Initially, the dispenser 1 is closed (FIGS. 1A and 3A) for periods of non-use. While the dispenser 1 is closed, the applicator 6 is submerged or in contact with a contained substance as mentioned above. Next, the plunger 3 of the closed dispenser 1 may be depressed to a locking engagement of the ratchet 14 and gear 17 (FIG. 3C) whereby the compressed spring 12 force is counteracted resulting in an open dispenser (FIGS. 1B, 2, and 3B). During the transition between closed and open configurations, the applicator 6 collects a substance and the wiper 16 removes the excess therefrom. The substance may be delivered to a target via contact with the exposed applicator 6. It is contemplated that the user may grip the body 2 of the dispenser 1 and thereby direct the applicator 6 in a particular delivery pattern. Finally, the plunger 3 of the open dispenser 1 (FIG. 3B) may be depressed to produce an unlocking engagement between the ratchet 14 and the gear 17 whereby the dispenser 1 reverts to a closed configuration (FIGS. 1A and 3A) under the spring 12 force.

Although the ratchet 14 primarily creates a locking/unlocking engagement with the gear 17, the ratchet 14 also serves another function. While moving within the reservoir from the rear of the reservoir 10 to the front, the ratchet 14 pushes contained substance from the back of the reservoir 10 to the front thereof for better collection on the applicator 6 while the dispenser 1 is closed and to generally mix the substance.

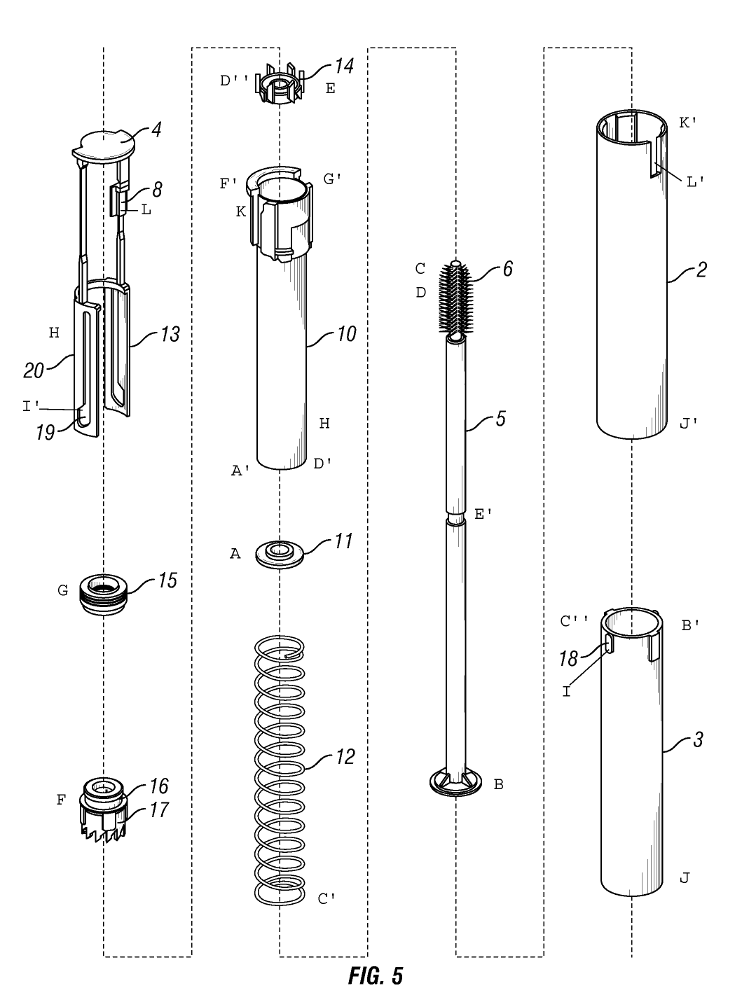

FIG. 5 is an exploded view of the dispenser 1. FIG. 5 not only provides a dispenser 1 assembly flow, but also an inventory of parts. Generally, the parts are related according to the dashed line begging in the bottom left to the top right of the figure. Assembly may be accomplished as follows: (1) the rear seal 11 may be positioned at the rear of the reservoir 10 (A to A′); (2) the spindle 5 plus applicator 6 may be inserted into the plunger 3 (B to B′); (3) the spring 12 may be inserted into the plunger (C′ to C″) while the applicator 6 is inserted into the spring (C to C′); (4) the spindle 5 plus applicator 6 may be inserted into the reservoir 10 (D to D′) and the ratchet 14 (D to D″) until the ratchet 14 is affixed at a point along the spindle 5 (E to E′); (5) the wiper 16 and gear 17 may be inserted into the reservoir 10 (F to F′); (6) the front seal may be placed affixed to the reservoir 10 (G to G′); (7) the cap press 13 may be placed around the reservoir 10 (H to H′) and plunger 3 whereby the nub 18 interacts with the slot 19 (I to I′); (8) finally, the entire assembly may be inserted into the front of the body 2 until the plunger 3 protrudes from the back (J to J′), the reservoir 10 affixes thereto (K to K′), and the cap guide 8 inserts thereto (L to L′).

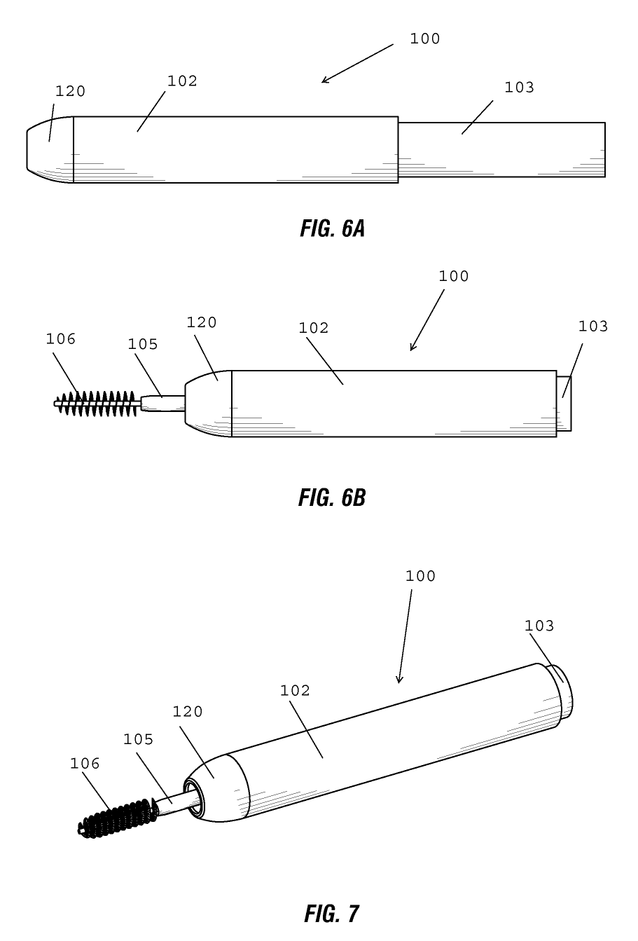

FIG. 6A is a side view of an alternate embodiment of this disclosure, namely, closed dispenser 100. More specifically, the figure shows a dispenser 100 with a cylindrical body 102, fully extended plunger 103, and a nose cone 120. FIG. 6B is a side view of an open dispenser 100. More specifically, the figure shows a dispenser 100 with a cylindrical body 102, a depressed plunger 103, and a spindle 105 plus applicator 106 protracted from the nose cone 120. FIG. 7 is a three-dimensional perspective of the open dispenser 100 of FIG. 6B. As discussed further below, the closed dispenser 100 of FIG. 6A is opened as in FIG. 6B or 7 via depressing the plunger 103 whereby the spindle 105 plus applicator 106 protrude from the nose cone 120 opening.

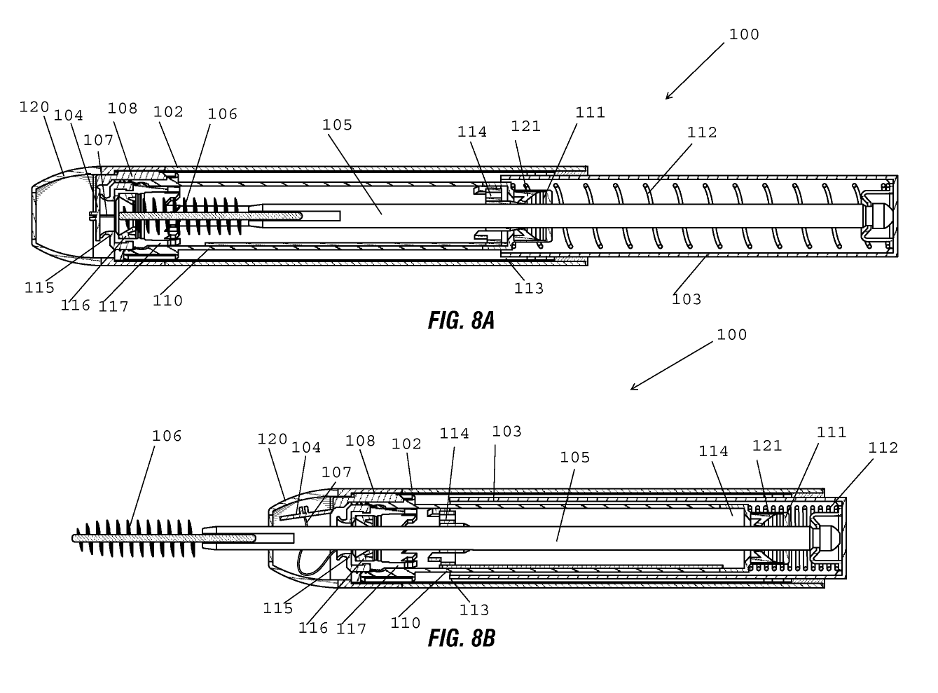

Referring again to FIG. 6A, the closed dispenser 100 is generally in the form of a hollow elongated cylinder. The plunger 103 defines a hemicylindrical end of the closed dispenser 100 and is preferably slightly less in diameter than the body 102 whereby the plunger 103 depressibly and coaxially merges within the body 102. Referring now to FIGS. 6B and 7, the plunger 103 can be substantially depressed into the body 102. As discussed later below, the depressive movement of the plunger 103 opens a cap 104 (see FIGS. 8A and 8B) that is underneath the nose cone 120 and protracts the spindle 105 plus applicator 106.

Still referring to FIGS. 6B and 7, the applicator 106 may preferably be in the nature of a twisted-in-wire-brush or other suitable design for application of substances with fluid or liquid, semi-liquid, quasi-liquid, or paste-like properties. Alternatively, the applicator 106 may be in the nature of a miniature comb, brush, preformed swab, sponge applicator, flocked applicator and the like.

FIGS. 8A and 8B are respectively longitudinal cross-sections of the closed and open dispenser 100 of FIGS. 6A, 6B and 7. FIGS. 8A through 8B depict the situation of the internal components during operation of the dispenser 100. As seen generally in the figures, the dispenser 100 internally typically comprises three integrally associated subassemblies: (1) the spindle assembly made up of the spring 112, the spindle 105, the ratchet 114, and the applicator 106; (2) the reservoir assembly comprising the reservoir 110, the rear seal 111, rear wiper 121, the gear 117, the wiper 116, and the front seal 115; and (3) the cap assembly made up of the cap 104, the cable 107, the cap guide 8, and the collar 113.

Inside the closed dispenser 100 of FIG. 8A, the spindle assembly movably occupies the length of the dispenser 100. More specifically, the spindle 5 extends from the butt of the plunger 103 through the expanded spring 112 to the applicator 6 within the closed cap 104 under the nose cone 120. Suitably, the ratchet 114 is fixedly attached to a point along the spindle 105. As discussed further below, a portion of the spindle assembly (from the ratchet 114 to the applicator 106) is within the reservoir assembly and preferably submerged in substance.

Still referring to the closed dispenser 100 of FIG. 8A, the reservoir assembly is fixedly positioned within the body 102 opposite to the plunger 103. The reservoir 110 preferably connects internally to the body 102 at the cap 104 end and extends internally toward the plunger 103. The front seal 115, the wiper 116, and the gear 117 fixedly occupy the cap 104 end of the reservoir 110 while the rear seal 111 and rear wiper 121 fixedly occupies the end toward the plunger 103. As mentioned above and discussed further below, the applicator 106, the ratchet 114, and a portion of the spindle 105 are preferably within the reservoir 110 when the dispenser 100 is closed whereby the ratchet 114 is adjacent to the inside butt of the reservoir 110. Also discussed further below, the rear seal 111 and wiper 121 close the reservoir 110 butt while slidably, circumferaly, and sealably interfacing with the spindle 105.

Now referring to the closed dispenser 1 of FIG. 8A, the cap assembly is preferably internally affixed to the body 102, movably extends internally within the body 102 along the outside of the reservoir 10, and mechanically connects to the plunger 103 via the collar 113. Specifically, the cap 104 is connected to the body 102 by the cap guide 108 and held against the front seal 115 of the reservoir by taut cables 107 under the force of the expanded spring 112. The interface of the cap 104 with the front seal 115 plugs the front of the reservoir whereby the closed dispenser 100 is capable of containing a substance within the reservoir 110. As discussed below, the cables 107 are made taut by the mechanical connection of the cap press 113 to the plunger 103.

Inside the open dispenser 100 of FIG. 8B, the spindle assembly is preferably internally shifted when compared with the closed dispenser of FIG. 8A. More specifically, the depression of plunger 103 compresses the spring 112 (between the plunger 103 butt and the reservoir 110) and drives the spindle 105 plus applicator 106 through the dispenser 100, preferably until the spindle 105 plus applicator 106 protrudes from the body 102. As depicted in the figure, the depressed plunger 103 coaxially enters the body 102 and simultaneously coaxially receives the reservoir 110. As depicted in the figure and discussed in further detail below, the ratchet 114 suitably shifts in conjunction with the spindle 105 to an interaction with the gear 117. Also discussed further below, the applicator 106 and spindle 105 interact with the wiper 116 while exiting the body 102 during plunger 103 depression.

Still referring to the open dispenser 100 of FIG. 8B, the reservoir assembly is fixedly positioned within the body 102 opposite to the plunger 103 like in the closed dispenser of FIG. 8A. Although the components of the other subassemblies move during plunger 103 depression, the reservoir assembly maintains a relative position within the body 102. Relative to the reservoir assembly, plunger 103 depression drives the applicator 106 through the reservoir 110 along and through the rear seal 111 and rear wiper 121 whereby the applicator 106 and spindle 105 exit the dispenser 100 at the front seal 15 and nose cone 120 opening. As the spindle 105 plus applicator 6 move through the reservoir 110, the wiper 116 interacts with the applicator 6 to remove excessive substance thereon. The wiper 116 also typically interacts with the spindle 105 in a similar manner as the rear seal 111 and rear wiper 121 whereby (1) substance is wiped away from the spindle 105 and remains within the reservoir 110, and (2) substance does not leak from the front seal 115 when upended while open. Also during plunger 103 depression, the ratchet 114 usually moves within the reservoir 110 to an interaction with the gear 117 for locking/unlocking the open configuration of the dispenser 1, as discussed above in connection with the earlier embodiment.

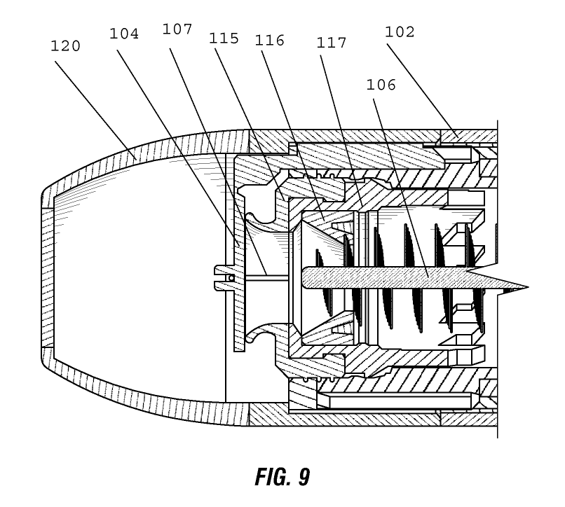

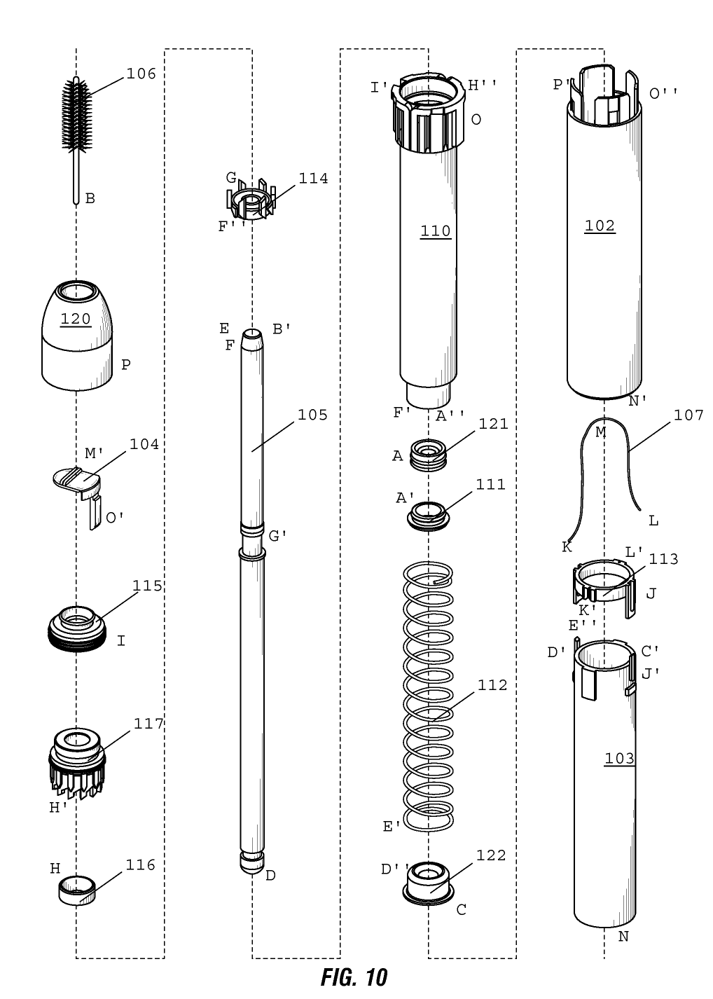

As mentioned above, the reservoir 10 features a front 115 and rear seal 111. Often, fluid materials used in cosmetic applications can quickly dry out when exposed to air. Accordingly, the applicator 6 and cosmetic substance should be cautiously exposed to air. To this end, the reservoir 110 has a rear seal 111 sized to receive the spindle 105 to create a substantially air tight seal without excessive force hindering movement of the spindle therethrough. Rear seal 111 is preferably constructed of an elastomeric material that maintains pliability. Likewise, the reservoir 110 features the front seal 115 for engaging the cap 104 to create a substantially airtight seal while the dispenser 100 is closed. This seal is depicted by FIG. 9. It should be noted, however, that although the dispenser 100 features the wiper 116 which, like the rear seal 111 and rear wiper 121, is sized to receive the spindle 105, the wiper 116/spindle 105 interface need not create an airtight seal. Rather, the wiper 116/spindle 105 interface need only (1) prevent the accumulation of substance on the spindle while outside the reservoir 110, and (2) prevent the leakage of substance from the reservoir 110 during dispenser 100 use. Front seal 115 is preferably constructed of an elastomeric material that maintains pliability.

Referring now to the open dispenser 100 of FIG. 8B, the cap assembly is preferably shifted within the dispenser 100 to open the cap 104. Specifically, plunger 3 depression drives the collar 113 through the body 2 and slackens the cables 107 whereby the cap 104 may be removed from the seal 115. Preferably, continued depression of the plunger 103 moves the applicator into contact with the cap and pushes the cap 104 off plain whereby the spindle 105 plus applicator 106 may exit the dispenser 100 unobstructedly.

It should be noted that the mechanisms for opening the cap 104 may vary according to the design of the dispenser 100. For instance, like the earlier disclosed dispenser 1, the presently disclosed dispenser 100 could be fitted with a cap press 13 whereby the cap 104 would open and close in a manner that is similar to that disclosed in reference to FIGS. 3D through 3F. Further, the cap 104 may be molded to the seal 115 whereby the cap 104, in conjunction with the cables 107 would operate to close the dispenser 100 in a manner similar to that disclosed by US. Pub. Pat. App. Nos. 20090245919 (published Oct. 1, 2009) and 20080175648 (published Jul. 24, 2008).

As stated above, plunger depression produces an open dispenser 1 as depicted in FIG. 8B. Conversely, plunger 103 extension (via expansion of the spring 12 or otherwise) produces a closed dispenser 100 as depicted in FIG. 8A due to the same mechanical connections and via the reverse of the above stated mechanisms.

As with the earlier embodiment of dispenser 1, the dispenser 100 of the present embodiment may be locked into an open configuration via the locking engagement of the ratchet 114 and gear 117. The mechanisms and details of the locking engagement are preferably similar to those discussed in connection with FIGS. 3C and 3F above.

FIGS. 6A through 8B depict a preferable dispenser 100 operation. Initially, the dispenser 100 is closed (FIGS. 6A and 8A) for periods of non-use. While the dispenser 100 is closed, the applicator 106 is submerged or in contact with a contained substance as mentioned above. Next, the plunger 103 of the closed dispenser 100 may be depressed to a locking engagement of the ratchet 114 and gear 117 whereby the compressed spring 112 force is counteracted resulting in an open dispenser (FIGS. 6B, 7, and 8B). During the transition between closed and open configurations, the applicator 106 collects a substance and the wiper 116 removes the excess therefrom. The substance may be delivered to a target via contact with the exposed applicator 106. It is contemplated that the user may grip the body 102 of the dispenser 100 and thereby direct the applicator 106 in a particular delivery pattern. Finally, the plunger 103 of the open dispenser 100 (FIG. 8B) may be depressed to produce an unlocking engagement between the ratchet 114 and the gear 117 whereby the dispenser 100 reverts to a closed configuration (FIGS. 6A and 8A) under the spring 112 force.

Although the ratchet 114 primarily creates a locking/unlocking engagement with the gear 117, the ratchet 114 also serves another function. While moving within the reservoir from the rear of the reservoir 110 to the front, the ratchet 114 pushes contained substance from the back of the reservoir 110 to the front thereof for better collection on the applicator 106 while the dispenser 100 is closed.

FIG. 10 is an exploded view of the dispenser 1. FIG. 5 not only provides a dispenser 100 assembly flow, but also an inventory of parts. Generally, the parts are related according to the dashed line begging in the top left to the bottom right of the figure. Assembly may be accomplished as follows: (1) the rear wiper 121 and rear seal 111 may be positioned at the rear of the reservoir 10 (A to A′ to A″); (2) the applicator 106 may be affixed to the spindle 105 (B to B′); (3) the stand 122 may be affixed to the inside butt of the plunger 103 (C to C′); (4) the spindle 105 plus applicator 106 may be inserted into the plunger 3 to connect to the stand 122 (D to D′ to D″); (5) the spring 112 may be inserted into the plunger (E′ to E″) while the applicator 6 is inserted into the spring (E to E′); (6) the spindle 105 plus applicator 106 may be inserted into the reservoir 110 (F to F′) and the ratchet 114 (F to F″) until the ratchet 114 is affixed at a point along the spindle 105 (G to G′); (7) the wiper 116 and gear 117 may be inserted into the reservoir 110 (H to H′ to H″); (8) the front seal 115 may be affixed to the reservoir 110 (I to I′); (9) the collar 13 may be placed around the plunger 103 (J to J′); (10) the cord may be strung from the collar to the cap 104 and back to the collar 113 (K to K′, L to L′, and M to M′); (8) the entire assembly may be inserted into the front of the body 102 until the plunger 103 protrudes from the back (N to N′) and the reservoir 110 and cap guide 108 are affixed thereto (O and O′ to O″); and, finally the nose cone 120 may be placed over the open end of the body 102 (P to P′).

The present disclosure represents an advancement over the prior art. The disclosed dispensers can withstand internal pressure of a contained volatile fluid (e.g., mascara) when closed, can store mascara and other volatile fluids for two years, and can store mascara and other volatile fluids for 60 days at elevated temperatures (forty-five degrees Celsius) with a less than four percent vapor loss of the fluid.

It should be noted that FIGS. 1A through 10 and the associated descriptions are of illustrative importance only. In other words, the depictions and descriptions of the present invention should not be construed as limiting of the subject matter in this application. The apparatuses, assemblies, components, and methods discussed hereby are susceptible to modification without changing the overall concept of the disclosed invention. For example, the position of the ratchet 14 or 114 and gear may be moved wherein the ratchet and gear are not within the reservoir 110 yet still operate to lock or unlock the dispenser 1 or 100 in an open configuration. Such modifications might become apparent to one skilled in the art after reading this disclosure.

I claim:

1. A substance dispenser comprising:
a spindle with an applicator on one end thereof;
a substance reservoir adapted to receive the spindle at a first location and to emit the applicator at a second location, wherein the spindle is slidably disposed through the first location whereby the spindle may be moved through the substance reservoir in order to collect substance on the applicator and emit the applicator at the second location; and,
a means for moving the spindle through the reservoir.

2. The dispenser of claim 1 further comprising a cap that is openable and closable by the means for moving the spindle through the reservoir due to is mechanical connection to the cap.

3. The dispenser of claim 1 wherein the cap is forcibly provided to the second location whereby the reservoir is sealed when closed.

4. The dispenser of claim 1 further comprising a wiper at the second location for removing fluid from the spindle passing therethrough.

5. The substance dispenser of claim 4 further comprising a seal at the first location that slidably interfaces with the spindle.

6. The substance dispenser of claim 5 wherein the first location further features a wiper for removing fluid from the spindle passing therethrough.

7. The dispenser of claim 1 wherein the means for moving the spindle is a plunger and spring assembly.

8. The dispenser of claim 2 wherein the mechanical connection is by a cap guide and cap shafts.

9. The dispenser of claim 2 wherein the mechanical connection is by a cable and collar.

10. The dispenser of claim 1 wherein the substance is mascara.

11. A method of applying a cosmetic substance comprising the steps of:
moving a spindle with an applicator on one end thereof through a substance reservoir adapted to receive the spindle at a first location and to emit the applicator at a second location, whereby substance is collected on the applicator and the applicator is emitted from the reservoir at the second location;
Contacting the applicator to a target; and,
Moving the spindle back through the reservoir whereby the applicator is within the reservoir.

12. The method of claim 11 further comprising the step of opening a cap at the second location while moving the spindle through the reservoir.

13. The method of claim 12 further comprising the step of forcibly providing the cap to the second location whereby the reservoir is sealed.

14. The method of claim 1 wherein the step of moving a spindle through the reservoir to collect substance is accomplished by depressing a plunger.

15. The method of claim 1 wherein the step of moving a spindle back through the reservoir is accomplished by expanding a spring.

16. A method of assembling a dispenser comprising the steps of:
Obtaining a spindle with an applicator on one end thereof;
Obtaining a substance reservoir;
receiving the spindle at a first location on the reservoir whereby the spindle is slidably disposed therethrough the first location, the spindle configured to be movable through the substance reservoir in order to collect substance on the applicator and emit the applicator at a second location; and,
installing a means for moving the spindle through the reservoir.

17. The method of claim 16 further comprising a the step of installing a cap that is openable and closable by the means for moving the spindle through the reservoir due to is mechanical connection to the cap.

18. The method of claim 16 further comprising the step of installing a wiper at the first location.

19. The method of claim 16 further comprising the step of installing a wiper at the second location.

20. The method of claim 16 wherein the means for moving the spindle is a plunger and spring assembly.

21. The apparatus of claim 2 wherein the cap is internally disposed on the dispenser.

22. The apparatus of claim 2 wherein the cap is externally disposed on the dispenser.
